(19) United States
(12) Patent Application Publication
(10) Pub. No.: US 2006/0256397 A1
(43) Pub. Date: Nov. 16, 2006

(54) Method and system for combining images

(75) Inventor: Chengwu Cui, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/127,884

(22) Filed: May 12, 2005

(51) Int. Cl. H04N 1/387

(52) U.S. Cl. 358/450; 358/474; 358/540

(57) ABSTRACT

A method and system for combining a first image and a second image where the first image and second image include an overlap portion. The method includes selecting a first stitch location for a line of pixels, calculating a first line edge value for the first stitch location, selecting a second stitch location, calculating a second line edge value for the second stitch location and comparing the line edge values. The final stitch location is selected based upon the line edge values. A second embodiment provides a method and system for selecting an algorithm for combining a first image and second image including an overlap portion. The method includes applying a first stitching algorithm to the overlap portion, calculating an overlap edge value, and comparing the overlap edge value to a predetermined threshold. If the overlap edge value is greater than the threshold, a second stitching algorithm is applied.

### FIELD OF THE INVENTION

The present invention relates to methods and systems for combining images to create a composite image, and particularly to combining partial images generated by a scanner.

### BACKGROUND

Scanners may be used to create digital images of documents. Typically, a narrow band of light is projected onto the document to be scanned. The incident light is reflected and/or refracted through a lens onto one or more arrays of sensor elements. The sensor elements generate image signal data representative of that portion of the document, generally known as a scan line. A scanner creates a digital image of a document by sampling the sensor elements while moving the scan area along the length of the document generating a series of scan lines, which when assembled form an image of the document.

Generally, a scan of the entire surface of the document is achieved during a single pass of the scan area over the full length of the document. However, if a document is too large to fit within the imaging area of the scanner, the document may be scanned in sections, creating two or more partial images of the document. In addition, some scanners include multiple arrays of sensor elements, such as camera scanners, configured to scan overlapping sections of a document, simultaneously generating two or more partial images. In either case, the resulting partial images may be combined or stitched together to create a complete image of the document.

A scanner or an image processor determines the relative positions of the partial images to combine the partial images and create a composite image of the document. Various features of the document or markers may be analyzed to establish the relative position of the partial images. Each partial image includes an overlap portion. The overlap portion of the partial images contains image data corresponding to the same area of the document.

Once the relative positions and overlap portions of the partial images have been established, the partial images may be combined to create a complete image. However, a highly visible, seam-like artifact may be created when the partial images are combined due to slight geometry differences between the partial images. The human visual system is particularly sensitive to misaligned features. Although the resolution limit of the retinal photoreceptors is about sixty arc seconds, the human visual system can resolve up to five arc seconds when aligning vernier targets, such as a pair of lines. Because of the heightened vernier acuity of the human visual system, also called hyper acuity, seam-like artifacts formed in misaligned document images are highly visible to the human eye. Accordingly, there is a need for a method and system for combining partial images to generate a composite image while minimizing the appearance of artifacts at the point at which the partial images are joined. In addition, there is a need for a metric for measuring such artifacts and evaluating the effectiveness of various algorithms in eliminating artifacts.

### SUMMARY

A method and system for combining images in which a first image and a second image include an overlap portion includes selecting a first stitch location for a line of pixels, calculating a first line edge value for the first stitch location, selecting a second stitch location for a line of pixels, calculating a second line edge value for the second stitch location, comparing the first and second line edge values and selecting a final stitch location. The first stitch location and second stitch location are located within the overlap portion. The final stitch location is selected based upon the first line edge value and the second line edge value.

In an alternate embodiment, a method and system for selecting an algorithm for combining images in which a first image and a second image include an overlap portion includes applying a first stitching algorithm to the overlap portion, calculating a first overlap edge value, comparing the first overlap edge value to a predetermined threshold and if the first overlap edge value is greater than the predetermined threshold, applying a second stitching algorithm to the overlap portion.

Objectives and advantages of the method and system for combining images will be apparent from the following descriptions, the accompanying drawings and the appended claims.

### BRIEF DESCRIPTION OF THE DRAWINGS

FIGS. 1(a) is a plan view of a large document;

FIG. 1(b) is a plan view of partial images of the document of FIG. 1(a);

FIG. 1(c) is a plan view of a composite image created from the partial images of FIG. 1(b);

FIG. 1(d) is a plan view of partial images of the document of FIG. 1(a) depicting a stitch path;

FIG. 1(e) is a plan view of a composite image created from the partial images and stitch path of FIG. 1(d);

FIG. 2 is a flow chart of the image processing logic executed by the imaging system of an embodiment of the method for combining images;

FIG. 3 is a flow chart of the image processing logic executed by the imaging system of an alternate embodiment of the method for combining images;

FIG. 4(a) is a schematic of an embodiment of an imaging system; and

FIG. 4(b) is a schematic of an alternate embodiment of an imaging system.

### DETAILED DESCRIPTION

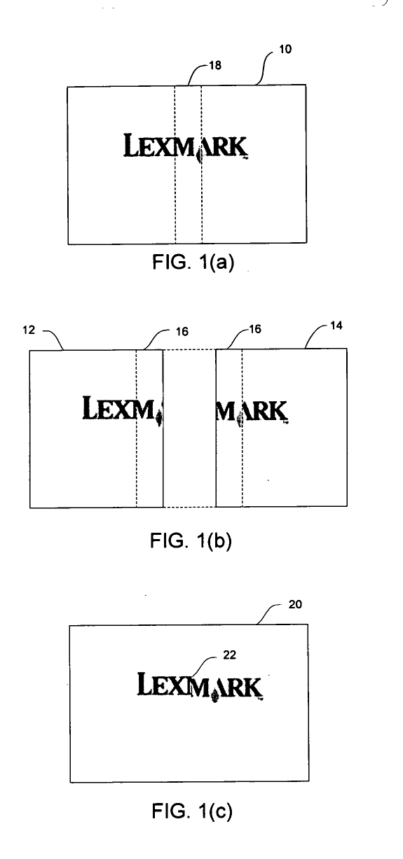

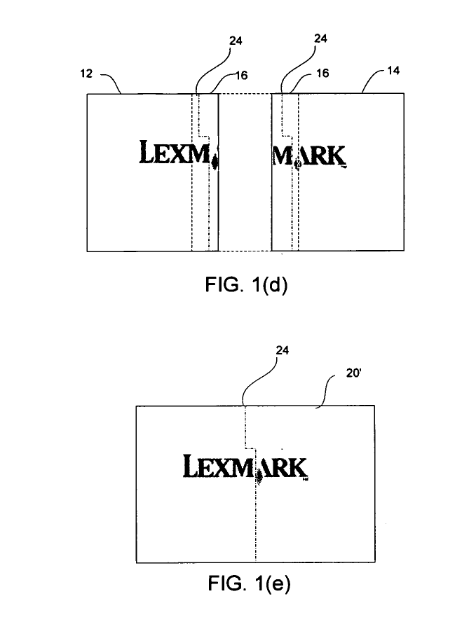

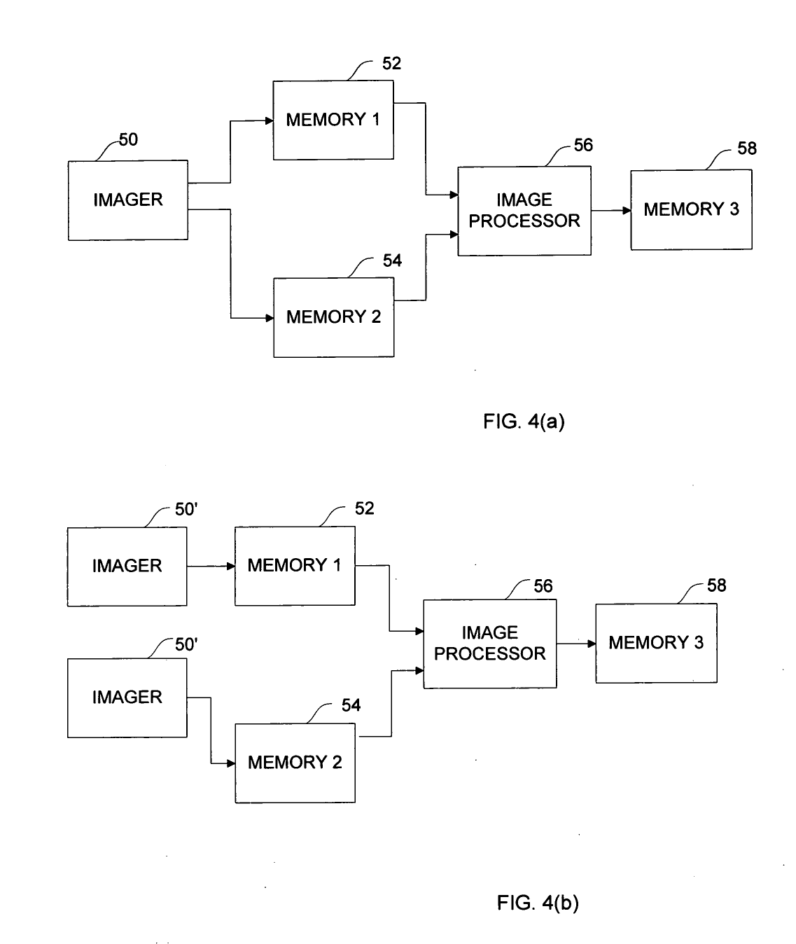

Referring now to FIGS. 1(a), 1(b), 1(c), FIG. 4(a) and FIG. 4(b), sections of a large document 10 may be scanned by an imager 50 to produce a first partial image 12 and a second partial image 14. Alternatively, a scanner may utilize multiple imagers 50′ to create partial images 12 and 14 from the document 10. The partial images may be stored in two or more areas of memory 52 and 54. Each partial image 12 and 14 may include an overlap portion 16 containing image data corresponding to an area 18 in document 10. The partial images 12 and 14 may be combined by an image processor 56 to create a composite image 20 of the document 10. The composite image 20 may be stored in memory 58 or output to an external device, such as a printer. If the partial images 12 and 14 are perfectly aligned and distortion free, the overlap portions 16 may be identical and the partial images 12 and 14 may be joined at any point in the overlap portion 16. However, minute differences between the overlap portions 16 may create a seam-like artifact 22 when the partial images are combined to create the composite image 20.

Referring now to FIGS. 1(d) and 1(e), an image processor 56 may determine a preferred stitch location for each line of pixels within the overlap portion. A stitch location, as used herein, is a dividing point in a line of pixels. For example, in the composite image 20, image data to the left of the stitch point may be from the first partial image 12 and image data to the right of the stitch point may be from the second partial image 14. The set of stitch locations that define the line joining the two partial images is referred to herein as the stitch path 24. The image processor may select stitch locations which form a stitch path 24 such that artifacts are minimized when the partial images 12 and 14 are combined to create a composite image 20′. A line of pixels may be either a scan line or a column of pixels depending upon the relative positions of the partial images. The line of pixels is a scan line when partial images are joined side by side, as shown in FIG. 1, and the line of pixels is a column of pixels when the top of one partial image is joined with the bottom of a second partial image (not shown).

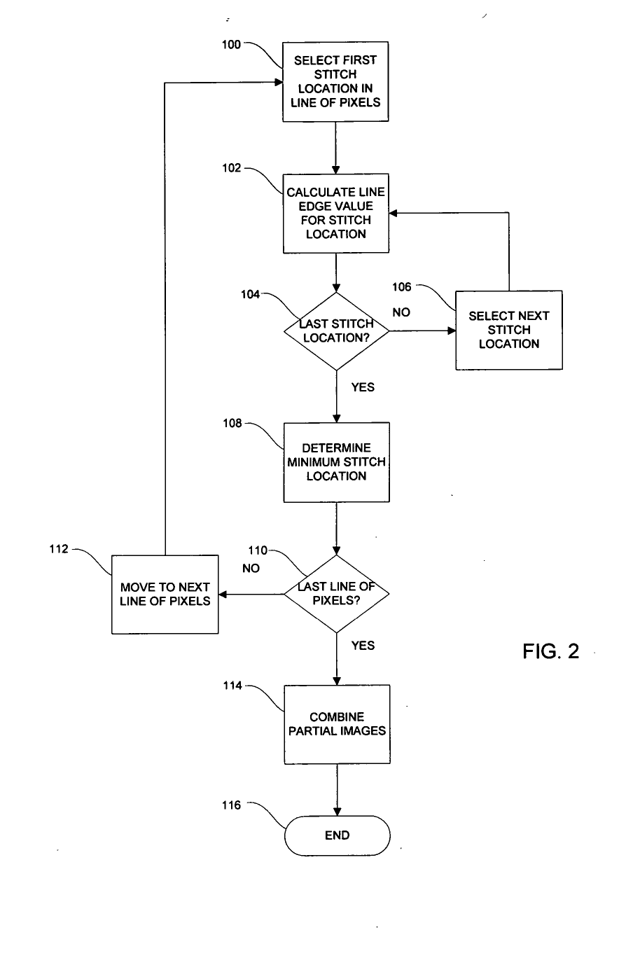

FIG. 2 shows an algorithm in which an image processor 56 may determine a stitch location for each line of pixels in a partial image based upon the value of the pixels. The value of a pixel may be expressed in any number of formats, such as RGB format. In the embodiment of FIG. 2, beginning at step 100, the image processor 56 selects a stitch location for a line of pixels. At step 102, the image processor 56 calculates the line edge value for the selected stitch location. In one embodiment the line edge value is based upon the difference between the value of the pixel from the first partial image adjacent to the stitch location and the value of the pixel from the second partial image adjacent to the stitch location. At step 104, the image processor 56 determines if all possible stitch locations in the line of pixels have been evaluated. The image processor 56 may process possible stitch locations from left to right within the overlap portions. If there are additional possible stitch locations, the image processor 56 selects the next stitch location at step 106 and returns to step 102 to calculate a line edge value for the new stitch location. In an alternate embodiment, the image processor 56 may compare the line edge value to a predetermined threshold, select stitch locations and calculate line edge values until a stitch location with a line edge value below the predetermined threshold is located.

Alternatively, the image processor 56 may determine the line edge value for each possible stitch location by manipulating arrays of pixel values rather than by selecting individual stitch locations and pixel values. The portion of each line of pixels within an overlap portion of the partial images is equivalent to an array of pixel values. Therefore, for every line of pixels there are two arrays of pixel values, one for the overlap portion of each partial image. To calculate the line edge value for each stitch location, the image processor 56 may shift the pixel values of one of the pixel arrays one position to the left or right within the array. The two arrays of pixel values may then be subtracted, resulting in an array of difference values. The array of difference values is equivalent to the set of line edge values for each possible stitch location.

Once the line edge value for each possible stitch location has been calculated, the image processor 56 determines the minimum line edge value at step 108. The stitch location corresponding to the minimum line edge value is selected as the stitch location for the line of pixels. At step 110, the image processor 56 determines if there are additional lines of pixels to process and if so, moves to the next line of pixels at step 112. The image processor 56 returns to step 100 to process any such additional lines of pixels. Once the stitch location has been determined for the last line of pixels, the image processor 56 combines the partial images at step 114 using the selected stitch locations to create the composite image.

The image processor 56 may store only the current minimum line edge value rather than storing a line edge value for each stitch location. For example, after calculating the line edge value for two stitch locations, the image processor 56 may store the line edge value and stitch location for the lowest line edge value as the current minimum line edge value and stitch location. The line edge value for the next possible stitch location is compared to the current minimum line edge value. If the next line edge value is less than the current minimum, the next line edge value and stitch location are stored as the current minimum line edge value and stitch location. If the new line edge value is greater than the current minimum, the current minimum line edge value and stitch location remain unchanged, and the image processor 56 will evaluate the next possible stitch location.

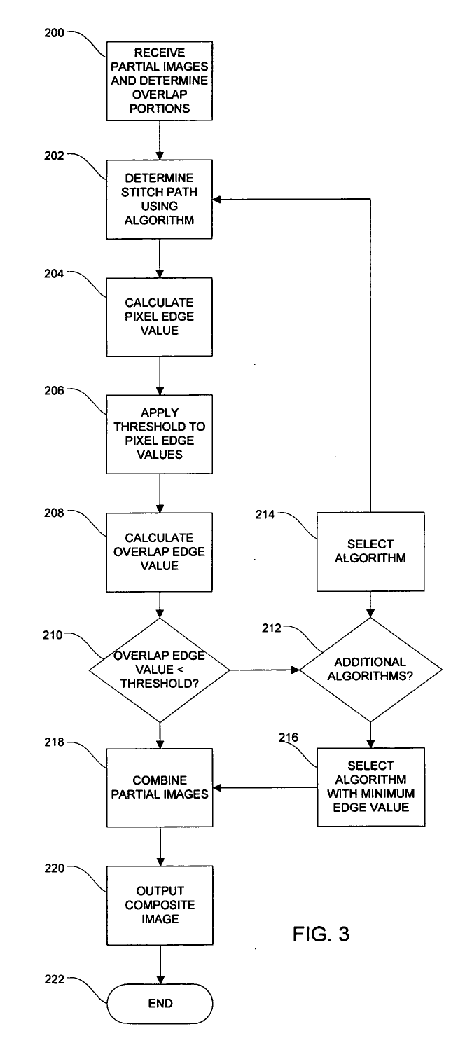

Referring now to FIG. 3, in an alternate embodiment, the image processor 56 may evaluate alternative document stitching algorithms. A document stitching algorithm, as used herein, is an algorithm or process for selecting the stitch path to combine partial images. Beginning at step 200, the image processor 56 receives two or more partial images and determines the overlap portion of each of the partial images. At step 202, the image processor 56 utilizes a first stitching algorithm to determine a stitch path to combine the partial images.

After determining a stitch path, the image processor 56 calculates an edge value for each pixel proximate to the stitch path at step 204. A pixel edge value may indicate a transition between pixels from light to dark or dark to light, signifying an edge. A large pixel edge value may correspond to an edge or transition visible to the human eye, such as an artifact. The pixel edge values may be calculated using an edge detection filter. When the two sides of the partial images are joined, as shown in FIG. 1, the artifacts created by joining the partial images may create one or more vertical lines. Accordingly, a vertical edge filter may be utilized to generate pixel edge values:

Vertical Edge Filter Matrix:

$$[ \begin{matrix}- 1 & 1 & 0 \\ - 1 & 1 & 0 \\ - 1 & 1 & 0\end{matrix} ] .$$

When the top of one partial image is joined with the bottom of a second partial image, the artifacts may create a horizontal line. Accordingly, a horizontal edge filter may be utilized to generate the pixel edge values:

Horizontal Edge Filter Matrix:

$$[ \begin{matrix}- 1 & - 1 & - 1 \\ 1 & 1 & 1 \\ 0 & 0 & 0\end{matrix} ]$$

To apply either the horizontal or vertical edge detection filters to a pixel, the pixel and the eight pixels that surround it are multiplied by the edge detection filter matrix. This matrix multiplication results in an edge value for each pixel. The pixel edge value indicates a transition from light to dark or dark to light, including transitions that occur in the original document. However, the pixel edge values affected by an artifact are generally greater than those generated by transitions within the underlying document. Typically, when a document is scanned, a low-pass filter is applied to the image data. Low-pass filters reduce the value of very high pixel values. Accordingly, there is less likely to be rapid change in pixel value between adjacent pixels within a partial image.

At step 206, the image processor 56 may apply a threshold to the pixel edge values, which may aid in eliminating pixel edge values that reflect transitions in the underlying document. For example, the image processor 56 may retain only the top ten percent (10%) of the pixel edge values. After filtering the pixel edge values, the image processor 56 may calculate the overlap edge value at step 208. The overlap edge value may be may be equal to the maximum of the pixel edge values. In an alternate embodiment, the overlap edge value may be equal to the sum of the pixel edge values. The overlap edge value may be used as a metric to evaluate the effectiveness of the stitching algorithm in preventing seam-like artifacts.

After calculating an overlap edge value, the image processor 56 may compare the overlap edge value to a predetermined threshold value at step 210. If the overlap edge value is greater than the threshold, the overlap portion may include an artifact visible to the human eye. At step 212 the image processor 56 determines whether there are any addition stitching algorithms to be evaluated. If so, the image processor 56 will select an additional algorithm at step 214 and return to step 202 to determine an alternate stitch path for the overlap portions of the partial images. If there are no additional algorithms, the image processor 56 will select the stitching algorithm and stitch path that produced the smallest overlap edge value at step 216. At step 218 the selected stitch algorithm is used to combine the partial images and generate a composite image. The composite image is output at step 220, and the stitching process terminates at step 222.

In an alternate embodiment, the image processor 56 may apply each of a set of stitching algorithms to the partial images. The image processor 56 may calculate an overlap edge value for each stitching algorithm and utilize the stitching algorithm having the smallest overlap edge value.

Each of the foregoing methods and systems may be applied to color image data. Color pixel data may be represented using a color space or color model such as RGB or YCbCr to numerically describe the color data. The RGB color space includes red, green and blue components. In the YCbCr color space, Y represents the luminance component and Cb and Cr represent individual color components for a pixel. Any of the components may be used as the pixel value when calculating stitch locations. The image processor 56 may treat the Y, Cb and Cr components as three distinct planes of data and process each set of components separately or may select stitch locations based solely upon the luminance component, Y.

The foregoing description of several methods and systems has been presented for the purposes of illustration. It is not intended to be exhaustive or to limit the invention to the precise procedures disclosed, and obviously many modifications and variations are possible in light of the above teaching. It is intended that the scope of the invention be defined by the claims appended hereto.

What is claimed is:

1. A method for combining a first image and a second image, wherein the first image and second image include an overlap portion, comprising:
selecting a first stitch location for a line of pixels wherein the first stitch location is located within the overlap portion;
calculating a first line edge value for the first stitch location;
selecting a second stitch location for the line of pixels wherein the second stitch location is located within the overlap portion;
calculating a second line edge value for the second stitch location;
comparing the first line edge value and the second line edge value; and
selecting a final stitch location for the line of pixels based upon the first line edge value and the second line edge value.

2. The method of claim 1, wherein the final stitch location is determined for each line of pixels within the overlap portion and further including combining the first image and the second image in accordance with the final stitch locations.

3. The method of claim 1, wherein the line of pixels is a scan line.

4. The method of claim 1, wherein the line of pixels is a column.

5. The method of claim 1, wherein calculating the first line edge value includes determining a difference between a first pixel and a second pixel, wherein the first pixel is adjacent to the first stitch location in the first image and the second pixel is adjacent to the first stitch location in the second image.

6. The method of claim 1, wherein the first image and the second image include color image data.

7. The method of claim 6, wherein the color image data is in YCbCr format and the line edge value is based upon a luminance.

8. A method for combining a first image and a second image, wherein the first image and the second image include an overlap portion, comprising:
selecting a first array of pixel values for a line of pixels from the overlap portion of the first image;
selecting a second array of pixel values for the line of pixels from the overlap portion of the second image;
shifting the pixel values of one of the first array and the second array at least one position within said array;
subtracting the second array from the first array to generate an array of difference values; and
selecting a stitch location for the line of pixels based upon the array of difference values.

9. The method of claim 8, wherein the stitch location is determined for each line of pixels within the overlap portion and further including combining the first image and the second image based upon the stitch locations.

10. A method for selecting an algorithm for combining a first image and a second image, wherein the first image and second image include an overlap portion, comprising:
applying a first stitching algorithm to the overlap portion to generate a first combined overlap portion; and
calculating a first overlap edge value for the first combined overlap portion.

11. The method of claim 10 further including:
comparing the first overlap edge value to a predetermined threshold; and
if the first overlap edge value is greater than the threshold, applying a second stitching algorithm to the overlap portion to generate a second combined overlap portion.

12. The method of claim 10 further including:
applying a second stitching algorithm to the overlap portion to generate a second combined overlap portion;
calculating a second overlap edge value for the second combined overlap portion;
comparing the first overlap edge value and the second overlap edge value; and
selecting the stitching algorithm with the lower overlap edge value.

13. The method of claim 10, wherein calculating the overlap edge value includes calculating a plurality of pixel edge values in the first combined overlap portion.

14. The method of claim 13, wherein the pixel edge values are calculated using an edge detection filter.

15. The method of claim 14, wherein the edge detection filter is a horizontal edge detection filter.

16. The method of claim 14, wherein the edge detection filter is a vertical edge detection filter.

17. The method of claim 13, wherein the overlap edge value is equal to the largest of the pixel edge values.

18. The method of claim 13, wherein the overlap edge value is equal to the sum of the pixel edge values.

19. The method of claim 13, wherein the overlap edge value is based upon the pixel edge values greater than a predetermined threshold.

20. A system for combining a first image and a second image, wherein the first image and second image include an overlap portion, comprising:
an imager for producing a first image and a second image;
an image processor for selecting a first stitch location for a line of pixels within the overlap portion, calculating a first line edge value for the first stitch location, selecting a second stitch location for the line of pixels within the overlap portion, calculating a second line edge value for the second stitch location, comparing the first line edge value and the second line edge value and selecting a final stitch location for the line of pixels based upon the first line edge value and the second line edge value; and
at least one memory for storing the first image and second image.

21. A system for selecting an algorithm for combining a first image and a second image, wherein the first image and second image include an overlap portion, comprising:
an imager for producing a first image and a second image;
an image processor for applying a first stitching algorithm to the overlap portion to generate a first combined overlap portion and calculating an overlap edge value for the first combined overlap portion; and
at least one memory for storing the first image, the second image and the combined overlap portion.

22. The system of claim 21, wherein the image processor compares the overlap edge value to a predetermined threshold and if the overlap edge value is greater than the threshold, applies a second stitching algorithm to the overlap portion to generate a second combined overlap portion.
